(19) United States
(12) Patent Application Publication
(10) Pub. No.: US 2025/0015927 A1
(43) Pub. Date: Jan. 9, 2025

(54) BASE STATION, TERMINAL, AND COMMUNICATION METHOD

(71) Applicant: Panasonic Intellectual Property Corporation of America, Torrance, CA (US)

(72) Inventors: Tomoya NUNOME, Ishikawa (JP); Hidetoshi SUZUKI, Kanagawa (JP); Ayako HORIUCHI, Kanagawa (JP); Yoshihiko OGAWA, Kanagawa (JP)

(21) Appl. No.: 18/712,205

(22) PCT Filed: Oct. 6, 2022
(86) PCT No.: PCT/JP2022/037367

§ 371 Date: May 21, 2024

(30) Foreign Application Priority Data
Dec. 1, 2021 (JP) 2021-195491

(51) Int. Cl. H04L 1/08; H04W 48/08

(52) U.S. Cl. CPC H04L 1/08; H04W 48/08

(57) ABSTRACT

A base station according to the present invention comprises: a control circuit that sets a plurality of sections, each of which includes at least one transmission opportunity for a plurality of synchronization signal blocks; and a transmission circuit that carries out repeated transmission of the synchronization signal blocks in the plurality of sections.

### TECHNICAL FIELD

The present disclosure relates to a base station, a terminal, and a communication method.

### BACKGROUND ART

The specification of a physical layer for Release 16 new radio access technology (NR) has been completed as functional enhancements of the 5th generation mobile communication systems (5G) in the 3rd generation partnership project (3GPP). NR supports functions for realizing ultra reliable and low latency communication (URLLC) in addition to enhanced mobile broadband (eMBB) to meet a requirement such as high speed and large capacity (see, e.g., Non Patent Literature (hereinafter, referred to as NPL) 1 to NPL 5).

### CITATION LIST

### Non-Patent Literature

### NPL 1

3GPP TS 38.211 V16.7.0, “NR; Physical channels and modulation (Release 16),” September 2021

### NPL 2

3GPP TS 38.212 V16.7.0, “NR Multiplexing and channel coding (Release 16),” September 2021

### NPL 3

3GPP TS 38.213 V16.7.0. “NR; Physical layer procedure for control (Release 16),” September 2021

### NPL 4

3GPP TS 38.214 V16.7.0, “NR; Physical layer procedures for data (Release 16),” September 2021

### NPL 5

3GPP TS 38331 V16.6.0, “NR; Radio Resource Control (RRC) protocol specification (Release 16).” September 2021

### NPL 6

3GPP TR 38.808 V17.0.0, “Study on supporting NR from 52.6 GHz to 71 GHz (Release 17),” March 2021

### SUMMARY OF INVENTION

However, there is room for study on a method for improving the reception quality of a signal in radio communications.

One non-limiting embodiment of the present disclosure facilitates providing a base station, a terminal, and a communication method each capable of improving the reception quality of a signal in radio communications.

A base station according to an embodiment of the present disclosure includes: control circuitry, which in operation, configures a plurality of sections including at least one transmission opportunity for a plurality of synchronization signal blocks; and transmission circuitry, which in operation, performs repetition transmission of the plurality of synchronization signal blocks in the plurality of sections.

It should be noted that general or specific embodiments may be implemented as a system, an apparatus, a method, an integrated circuit, a computer program, a storage medium, or any selective combination thereof:

According to an embodiment of the present disclosure, the reception quality of a signal can be improved in radio communications.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary relation between a Discovery burst transmission window (DBTW) and SS/PBCH Blocks (SSBs);

FIG. 2 illustrates exemplary SSB transmission timings;

FIG. 3 is a block diagram illustrating an exemplary configuration of a part of a base station;

FIG. 4 is a block diagram illustrating an exemplary configuration of a part of a terminal;

FIG. 5 is a block diagram illustrating an exemplary configuration of the base station;

FIG. 6 is a block diagram illustrating an exemplary configuration of the terminal:

FIG. 7 is a sequence diagram illustrating exemplary operations of the base station and the terminal;

FIGS. 8A and 8B illustrate exemplary relations between DBTWs and SSBs;

FIG. 9 illustrates exemplary SSB transmission positions in each DBTW;

FIGS. 10A and 10B illustrate exemplary relations between DBTWs and SSB transmission positions;

FIGS. 11A and 11B illustrate an exemplary method for identifying an SSB transmission position using a Demodulation Reference Signal (DMRS) sequence;

FIGS. 12A and 12B illustrate exemplary DBTW periods;

FIG. 13 illustrates an exemplary architecture for a 3GPP NR system;

FIG. 14 schematically illustrates a functional split between Next Generation-Radio Access Network (NG-RAN) and 5th Generation Core (5GC);

FIG. 15 is a sequence diagram of a Radio Resource Control (RRC) connection setup/reconfiguration procedure;

FIG. 16 is a schematic diagram illustrating usage scenarios of enhanced Mobile BroadBand (eMBB), massive Machine Type Communications (mMTC), and Ultra Reliable and Low Latency Communications (URLLC); and

FIG. 17 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

In Release 17 NR, for example, functional enhancement for realizing communications in frequencies from 52.6 GHz to 71 GHz has been studied.

One of the functional enhancements is to support subcarrier spacing (SCS) such as 480 kHz or 960 kHz higher than the existing SCS. In order to perform processing such as initial connection or beam management with such SCS, functional enhancement of SS/PBCH Block (SSB, or also referred to as synchronization signal block) has been studied. SSB is composed of, for example, a Primary Synchronization Signal (PSS), a Secondary Synchronization Signal (SSS), and a broadcast channel (e.g., Physical Broadcast Channel (PBCH)). PSS and SSS are synchronization signals. For example, a terminal (e.g., also referred to as User Equipment (LIE)) synchronizes with a carrier wave using at least one of PSS and SSS.

For example, in a high frequency band, transmission beamforming may be applied on a base station (e.g., also referred to as gNB) side to have a communicable distance and area between the base station and a terminal. In NR, a beam management functionality using SSB is introduced, for example. For example, transmitting SSBs of different SSB indexes in an SS burst by different downlink transmission beams allows “beam-sweeping,” by which SSBs are transmitted while the beam direction is sequentially changed. The beams may be analogue beams. Here, a set of SSBs (e.g., set of SSBs of different indexes) is referred to as an “SSB burst.” For example, an SSB burst may be transmitted at a {5/10/20/40/80/160} ins period.

Further, when SSB corresponds to 480 or 960 kHz SCS, the coverage possibly decreases compared with that of 120 kHz SCS. For example, NPL 6 reported that the link budget decreases by 5 dB with 480 kHz SCS, and the link budget decreases by 8 dB with 960 kHz SCS.

In one non-limiting embodiment of the present disclosure, a method for suppressing reduction in SSB coverage with SCS larger than the existing values (e.g., 120 kHz SCS), such as 480 or 960 kHz SCS, will be described. According to a non-limiting embodiment of the present disclosure, the coverage of SSB can be improved, and the reception quality of SSB can be enhanced.

### [Discovery Burst Transmission Window (DBTW)]

SSB coverage enhancements include, for example, a method for repeatedly transmitting (e.g., also referred to as repetition) SSB (or SSB burst).

When SSB burst is repeatedly transmitted by repetition, for example, the effect of DBTW including at least one candidate for a transmission section (or transmission opportunity) of SSB burst needs to be considered.

For example, in an unlicensed band (e.g., also referred to as “NR-Unlicensed (NR-U)” band), a signal is transmitted after the confirmation of whether the signal transmission band is used by another radio station (referred to as carrier sensing or Listen Before Talk (LBT)). When LBT failure occurs, a base station or a terminal cannot transmit a signal. Thus, for example, there is possibly a case that SSB burst cannot be transmitted from the beginning of a set transmission timing (e.g., half frame (e.g., 5 ms)). Accordingly, the base station possibly does not transmit SSB at SSB transmission positions in the vicinity of the beginning of the SSB burst. Note that LBT failure may be referred to as' “channel busy” or “LBT busy.”

In DBTW, for example, cyclic transmission of SSB index can be performed at different SSB transmission positions (e.g., different transmission opportunities) within a transmission section corresponding to the DBTW. In DBTW, a candidate position where SSB can be transmitted is referred to as a “candidate SSB position.”

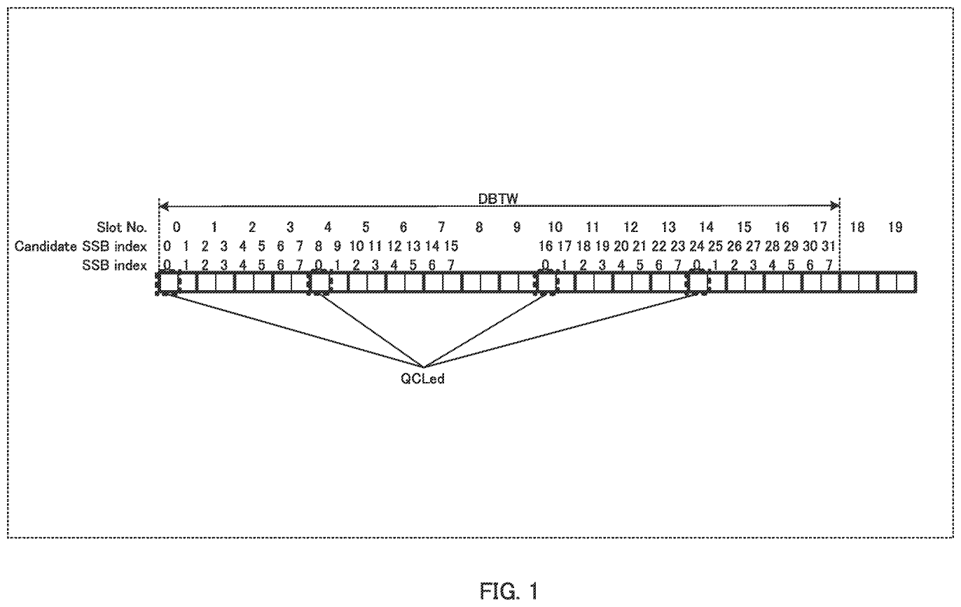

FIG. 1 illustrates a relation between a DBTW and SSBs;

In the example illustrated in FIG. 1, “N_{SSB}^{QCL}” representing the number of beams that can be transmitted within an SSB burst is set to eight, and candidate SSB positions within a DBTW are set to 32. Indexes of candidate SSB positions “candidate SSB index” may be sequentially mapped to SSB indexes, for example, based on N_{SSB}^{QCL}. For example, in FIG. 1, Candidate SSB indexes 0 to 31 are sequentially mapped to SSB indexes 0 to 7 of SSBs of N_{SSB}^{QCL}=8.

For the SSBs of the same SSB index, the same SSB beam is transmitted (e.g., may be referred to as “QCL (quasi co-located)” SSB). For example, in the DBTW illustrated in FIG. 1, SSB indexes 0 to 7 are present four times each. Thus, even when SSB is not transmitted at a certain timing in a DBTW due to LBT failure, a base station can transmit the SSB am another transmission timing (e.g., transmission opportunity) in the DBTW. In the example of FIG. 1, there are up to four transmission opportunities for each SSB index.

Accordingly, applying DBTW can increase SSB transmission opportunities.

### [PBCH Transmission Timing]

At a terminal, for example, in order to combine PBCHs included in SSBs to be transmitted by repetition, the payload of PBCH (content of pre-coded bits transmitted by PBCH) is expected to be the same between the plurality of PBCHs that are transmitted by repetition.

For example, as described above, PBCH includes fields the contents of which possibly vary depending on the transmission timing.
System frame number (SFN): Indicates a frame number (changes every 10 ins)
Half frame bit: Indicates whether the slot in which SSB is mapped is in the first half or the second half in a frame (changes every 5 ns)
Candidate SSB index: Indicates the index of a Candidate SSB position (changes for each candidate SSB position)

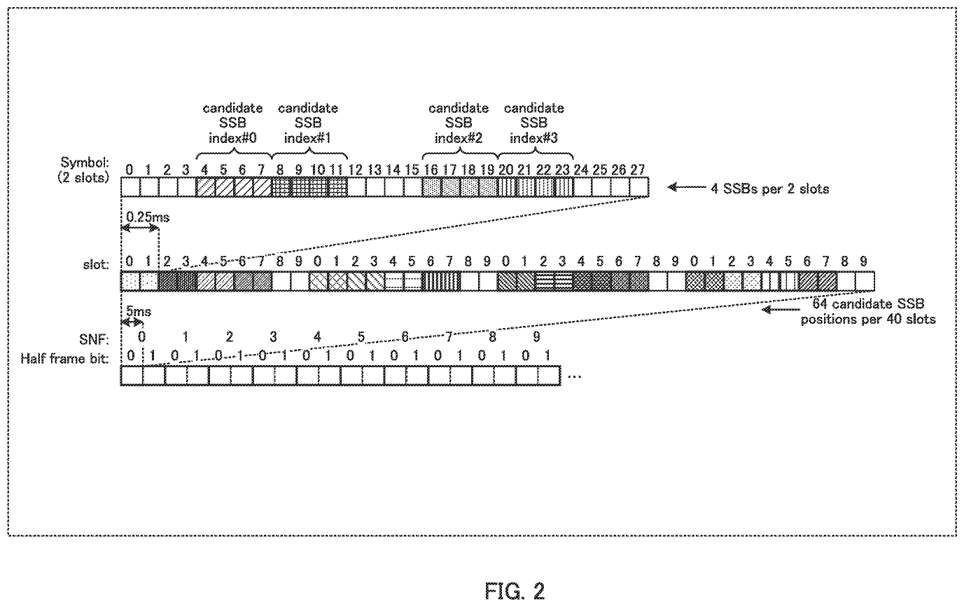

FIG. 2 illustrates exemplary SSB transmission timings in 120 kHz SCS (e.g., 80 slots per frame).

The first row from the top in FIG. 2 illustrates an example in which four candidate SSB positions are present per two slots. As illustrated in FIG. 2, a candidate SSB index varies (e.g., candidate SSB indexes 0 to 3) for every four candidate SSB positions.

The second row from the top in FIG. 2 illustrates an example in which SSB can be transmitted in 32 slots among 40 slots (e.g., half frame), and 64 candidate SSB positions (e.g., two candidate SSB positions per slot) are included. Further, the third row from the top in FIG. 2 illustrates a relation between the 40 slots of the second row, SFN, and half frame bit. As illustrated in FIG. 2., SFN changes every 10 ms, and Half frame bit changes every 5 ms.

The PBCH (or SSB) transmission timing has been described above.

In anon-limiting embodiment of the present disclosure, for example, SSB repetition transmission considering at least one of the above-described DBTW configuration and PBCH transmission timing will be described.

### [Overview of Communication System]

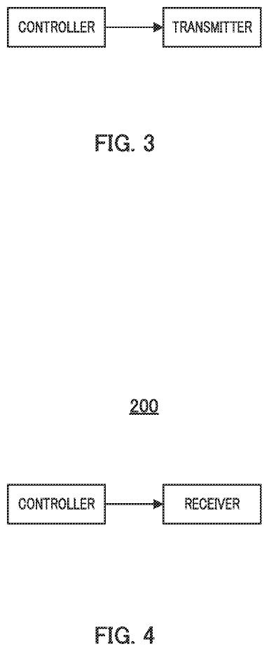

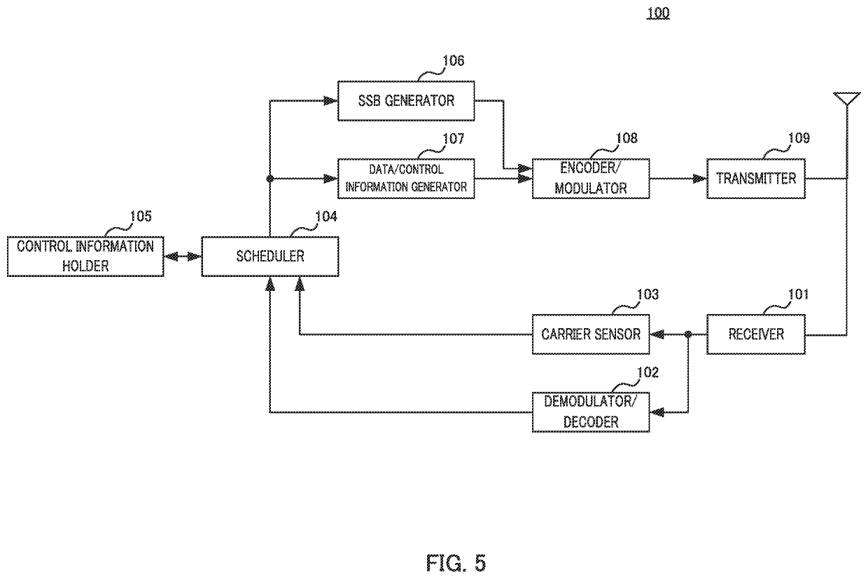

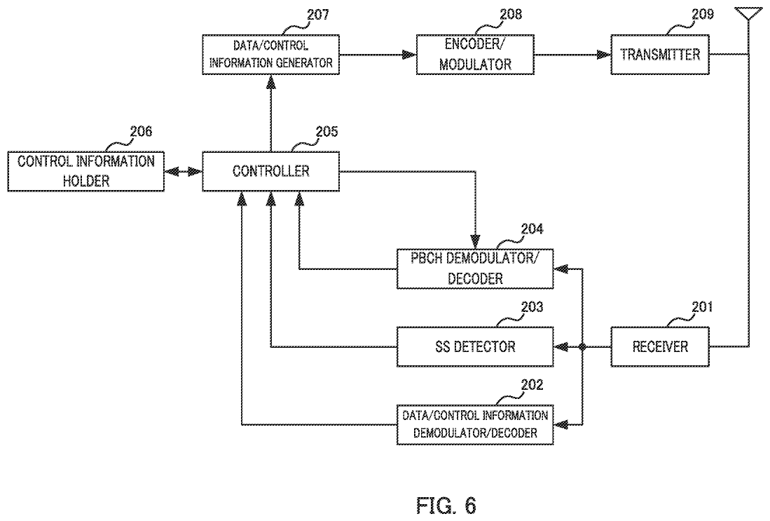

A communication system according to an aspect of the present disclosure may include, for example, base station 100 illustrated in FIGS. 3 and 5 and terminal 200 illustrated in FIGS. 4 and 6. The communication system may include a plurality of base stations 100 and a plurality of terminals 200.

FIG. 3 is a block diagram illustrating an exemplary configuration of a part of base station 100 according to an aspect of the present disclosure. In base station 100 illustrated in FIG. 3, a controller (e.g., corresponding to control circuitry) configures a plurality of sections (e.g. DBTWs) including at least one transmission opportunity for a plurality of synchronization signal blocks (e.g., SSB). A transmitter (e.g., corresponding to transmission circuitry) performs repetition transmission of the plurality of synchronization signal blocks in the plurality of sections.

FIG. 4 is a block diagram illustrating an exemplary configuration of a part of terminal 200 according to an aspect of the present disclosure. In terminal 200 illustrated in FIG. 4, a controller (e.g., corresponding to control circuitry) configures a plurality of sections including at least one transmission opportunity for a plurality of synchronization signal blocks. A receiver (e.g., corresponding to reception circuitry) receives a repetition transmission of the plurality of synchronization signal blocks in the plurality of sections.

### [Configuration of Base Station]

FIG. 5 is a block diagram illustrating an exemplary configuration of base station 100 according to an aspect of the present disclosure. In FIG. 5, base station 100 includes receiver 101, demodulator/decoder 102, carrier sensor 103, scheduler 104, control information holder 105, SSB generator 106, data/control information generator 107, encoder/Modulator 108, and transmitter 109.

Note that, for example, at least one of demodulator/decoder 102, carrier sensor 103, scheduler 104, control information holder 105, SSB generator 106, data/control information generator 107, and encoder/modulator 108 may be included in the controller illustrated in FIG. 3, and transmitter 109 may be included in the transmitter illustrated in FIG. 3.

For example, receiver 101 performs reception processing such as down-conversion or A/D conversion on the received signal received via the antenna, and outputs the received signal after the reception processing to demodulator/decoder 102 and carrier sensor 103.

For example, demodulator/decoder 102 demodulates and decodes the received signal (e.g., uplink signal) inputted from receiver 101 and outputs the decoding result to scheduler 104.

Carrier sensor 103 may perform carrier sensing (e.g., LBT) based on the received signal inputted from receiver 101, for example. For example, carrier sensor 103 may determine whether the channel status is “busy” (e.g., LBT failure) or “idle” (e.g., LBT success) (in other words, whether or not the channel is available) based on the received signal inputted from receiver 101. Carrier sensor 103 outputs information indicating the determined channel status to scheduler 104.

For example, scheduler 104 determines information on SSB transmission based on control information inputted from control information holder 105 and the information indicating the channel status inputted from carrier sensor 103, and indicates generation of SSB to SSB generator 106 based on the determined information. The information on SSB transmission may include, for example, at least one of an SSB transmission timing, transmission contents of SSB (e.g., PBCH), or a DBTW configuration. Further, scheduler 104 may, for example, output the information on SSB transmission to control information holder 105.

Further, scheduler 104 performs scheduling of data or control information for terminal 200 based on at least one of the decoding result inputted from demodulator/decoder 102 and the control information inputted from control information holder 105, and indicates generation of data or control information to data/control information generator 107 based on the scheduling result.

Control information holder 105 holds, for example, control information on SSB transmission (e.g., information on N_{SSB}^{QCL} or DBTW size). For example, control information holder 105 may output the held information to each component (e.g., scheduler 104) of base station 100 as needed.

For example, SSB generator 106 generates SSB in accordance with the generation indication inputted from scheduler 104. The generation indication may include, for example, an SSB transmission timing or transmission contents of SSB. SSB generator 106 outputs, for example, a signal sequence of the generated SSB (e.g., may include a signal sequence of PSS/SSS, PBCH data, and a signal sequence of PBCH-DMRS) to encoder/modulator 108.

Data/control information generator 107, for example, generates control information in accordance with the indication from scheduler 104 and outputs the generated control information to encoder/modulator 108. Further, data/control information generator 107 generates data in accordance with the indication from scheduler 104 and outputs the generated data to encoder/modulator 108.

Encoder/modulator 108, for example, encodes and modulates the SSB signal sequence inputted from SSB generator 106 and/or the signal inputted from data/control information generator 107 as needed, and outputs the signal after the modulation to transmitter 109.

Transmitter 109 performs transmission processing such as D/A conversion, up-conversion, or amplification on the signal inputted from encoder/modulator 108, for example, and transmits a radio signal obtained by the transmission processing to terminal 200 through the antenna.

### [Configuration of Terminal]

FIG. 6 is a block diagram illustrating an exemplary configuration of terminal 200 according to an aspect of the present disclosure. In FIG. 6, terminal 200 includes receiver 201, data/control information demodulator/decoder 202, SS detector 203, PBCH demodulator/decoder 204, controller 205, control information holder 206, data/control information generator 207, encoder/modulator 208, and transmitter 209.

Note that, for example, at least one of data/control information demodulator/decoder 202, SS detector 203, PBCH demodulator/decoder 204, controller 205, control information holder 206, data/control information generator 207, and encoder/modulator 208 may be included in the controller illustrated in FIG. 4, and receiver 201 may be included in the receiver illustrated in FIG. 4.

For example, receiver 201 performs reception processing such as down-conversion or A/D conversion on the received signal received via, the antenna, and outputs the received signal after the reception processing to data/control information demodulator/decoder 202, SS detector 203, and PBCH demodulator/decoder 204.

For example, data/control information demodulator/decoder 202 demodulates and decodes the received signal inputted from receiver 201 and outputs the result of decoding the control information to controller 205.

SS detector 203, for example, detects a synchronization signal (e.g., PSS and SSS) by performing correlation processing or the like on the received signal (e.g., including SSB) inputted from receiver 201, and outputs the detected SS information (e.g., including physical cell ID) to controller 205.

PBCH demodulator/decoder 204, for example, demodulates and decodes a PBCH included in the received signal (e.g., including SSB) inputted from receiver 201, based on decoding indication inputted from controller 205, and outputs the information on PBCH to controller 205. The decoding indication may include, for example, SS information and repetition information. Further, the information on PBCH may include, for example, a PBCH decoding result and DMRS sequence information. Further, for example, when decoding PBCH, PBCH demodulator/decoder 204 may combine the PBCH received this time and the soft decision value of the previously received PBCH, and then perform the decoding processing.

Controller 205, for example, indicates decoding to PBCH demodulator/decoder 204 based on the SS information inputted from SS detector 203. Further, for example, controller 205 determines control information based on the information on PBCH inputted from PBCH demodulator/decoder 204, and outputs the information to control information holder 206. The control information may include, for example, at least one of N_{SSB}^{QCL} an SSB index, SFN, a slot-number, and a DBTW configuration.

Further, controller 205 may, for example, indicate generation of data or control information to data/control information generator 207 based on the decoding result inputted from data/control information demodulator/decoder 202.

Control information holder 206, for example, holds the control information inputted from controller 205, and outputs the held information to each component (e.g., controller 205) as needed.

For example, data/control information generator 207 generates data or control information in accordance with the indication from controller 205 and outputs a signal including the generated data or control information to encoder/modulator 208.

Encoder/modulator 208 encodes and modulates the signal inputted from data/control information generator 207 and outputs the modulated transmission signal to transmitter 209.

Transmitter 209 performs transmission processing such as D/A conversion, up-conversion, or amplification on the signal inputted from encoder/modulator 208, for example, and transmits a radio signal obtained by the transmission processing through the antenna to base station 100.

### [Operations of Base Station 100 and Terminal 200]

Exemplary operations of base station 100 and terminal 200 having the above configurations will be described.

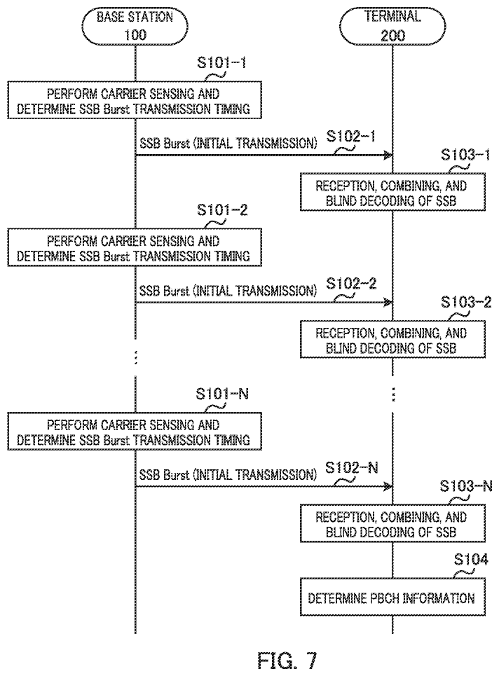

FIG. 7 is a sequence diagram illustrating exemplary operations of base station 100 and terminal 200.

For example, base station 100 may perform carrier sensing (e.g., LBT) for transmission of SSB burst, and determine an SSB burst transmission timing based on the carrier sensing result (S101-1).

For example, base station 100 may transmit an SSB burst (initial transmission) at the determined transmission timing (S102-1).

Terminal 200 may detect SS (e.g., PSS/SSS), combine PBCHs, and perform blind decoding based on the received SSB burst (S103-1), for example.

Further, base station 100 may perform repetition transmission of SSB burst, for example. For example, when transmitting the SSB burst a total of N times by repetition transmission, base station 100 and terminal 200 may repeatedly perform the same processing as in S101-1, S102-1 and S103-1 N times. Note that an exemplary method for repetition transmission of SSB burst will be described later.

For example, when succeeding in decoding PBCH in an SSB burst, terminal 200 may determine information on PBCH (e g., SFN, slot-number, and the like) (S104).

### [SSB Burst Repetition Method]

Next, an exemplary SSB burst repetition method at base station 100 (e.g., scheduler 104) is described. Note that terminal 200 (e.g., controller 205) may, for example, perform reception control, assuming transmission control performed by base station 100 based on the SSB burst repetition method.

In the present embodiment, for example, a plurality of “SSB burst transmission candidate sections,” which are sections available for transmitting SSB burst, may be defined (or configured). The plurality of SSB burst transmission candidate sections may be defined as, for example, an “SSB burst transmission candidate section set.”

The SSB burst transmission candidate section set may, for example, correspond to repetition of SSB burst. Further, the SSB burst transmission candidate section may include, for example, at least one transmission opportunity for SSB burst. Base station 100 may transmit SSB burst, for example, in each of a plurality of SSB burst transmission candidate sections within an SSB burst transmission candidate section set.

For example, the SSB burst transmission candidate section may be a DBTW. In the following description, for example, a section collecting a plurality of DBTWs is defined as a “DBTW set.” The following description is given of the case where the SSB burst transmission candidate section is a DBTW as an example. Base station 100 may, for example, perform repetition transmission of SSB burst in a plurality of DBTWs, and terminal 200 may receive the repetition transmission of SSB burst in the plurality of DBTWs.

For example, in the case of 480 kHz SCS, since the slot length is shorter than that of 120 kHz SCS, SSB burst can be transmitted in a shorter period in time even though the number of candidate SSB positions is the same. For example, in the case of 120 kHz SCS, 64 candidate SSB positions are mapped within 5 ms (e.g., see FIG. 2), whereas, in the case of 480 kHz SCS, 64 candidate SSB positions can be mapped within 1 Ins. Note that a period in which candidate SSB positions are mapped is also affected by a difference in slot in which SSB is mapped.

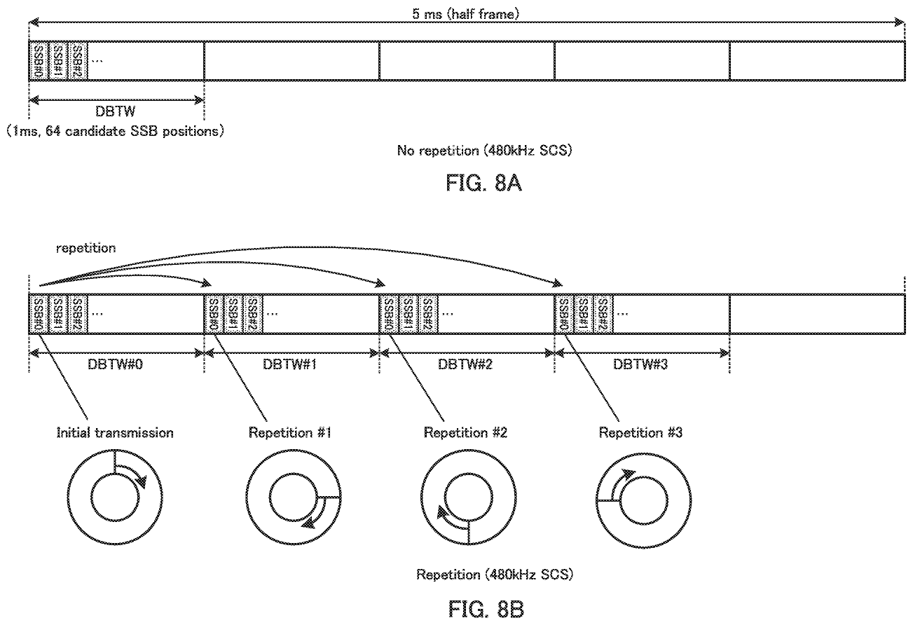

FIGS. 8A and 8B illustrate relations between DBTWs and SSBs.

As illustrated in FIG. 8A, 64 candidate SSB positions fall within 1 ins with 480 kHz SCS.

In the present embodiment, a DBTW set including a plurality of DBTWs may be defined, and, for the DBTW illustrated in FIG. 8A, additional DBTWs may be mapped to the remaining area (e.g., period) within 5 ms (e.g., half frame). For example, as illustrated in FIG. 8B, DBTW #1, DBTW #2, and DBTW #3 may be added to the existing DBTW (e.g., corresponding to DBTW #0). For example, DBTW #1, DBTW #2, and DBTW #3 may be used as DBTWs for SSBs to be repetition transmitted.

Base station 100 and terminal 200 may, for example, configure a DBTW set illustrated in FIG. 8B for SSB burst.

Further, terminal 200 can detect, for example, a status in which SSB repetition is enabled or disabled (e.g., status of either FIG. 8A or FIG. 8B) and the position of SSB in a half frame by blind decoding.

Furthermore, terminal 200 may distinguish DBTWs from one another by for example, varying the transmission start position of a PBCH included in SSB in a circular buffer for each DBTW. For example, information identifying each of the plurality of DBTWs in a DBTW set (e.g., DBTW index) and the transmission start position of the PBCH included in SSB in a circular buffer may be associated with each other. For example, as illustrated in FIG. 8B, PBCH may be transmitted from the starting position of the circular buffer in DBTW #0, and PBCH may be transmitted from the middle of the circular buffer and a position different for each DBTW in each of DBTWs #1 to #3.

Note that the transmission start positions of PBCHs illustrated in FIG. 8B are merely examples and may be different from the actual transmission start positions.

Terminal 200 may perform processing of combining and decoding PBCHs, for example, assuming that different transmission start positions of PBCHs in a circular buffer are respectively used for a plurality of DBTWs. For example, in the example of FIG. 8B, terminal 200 may attempt blind decoding four times. When terminal 200 can decode PBCH correctly, terminal 200 can detect the position of SSB within a half frame. Further, for example, when terminal 200 can decode PBCH correctly, terminal 200 can identify what number the DBTW is in a DBTW set, according to the transmission start position assumed on the PBCH in a circular buffer. Note that, in FIG. 8B, since PBCHs in DBTWs #1 to #3 are repetitions of PBCH of DBTW #0 (in other words, since the PBCH payload is the same), PBCHs can be combined between DBTWs #0 to #3.

### [PBCH Transmission Method]

Next, in exemplary, configuration of a transmission start position of PBCH in a circular buffer is described.

### Configuration Method 1

In Method 1, for example, the transmission start position of PBCH in a circular buffer may be configured at a position contiguous with the transmission end position of the PBCH in the preceding DBTW.

The transmission start position of PBCH in a circular buffer may be determined, for example, based on a PBCH payload size (or the number of encoded PBCH bits), a physical resource size for PBCH (e.g., the number of resource elements available for PBCH transmission), and a DBTW number in a DBTW set.

The transmission start position of PBCH in a circular buffer may be herein a parameter that is uniquely determined regardless of whether or not SSB is transmitted. For example, the transmission start position of PBCH in a circular buffer may be associated with a DBTW number. Thus, for example, even when base station 100 does not transmit SSB in a certain DBTW of a DBTW set, base station 100 and terminal 200 may determine the transmission start position corresponding to the subsequent DBTW, considering the transmission start position of PBCH in a circular buffer corresponding to the DBTW (e.g., assuming that SSB has been transmitted in the DBTW).

For example, when the number of encoded PBCH bits is 512 bits, the PBCH resource size is 432 resource elements (which corresponds to 864 bits when modulated by QPSK) and the number of DBTWs is four, the transmission start position in each of DBTWs is determined as follows.
DBTW #0: 0((512*0) rod 864)
DBTW #1: 512((512*1) mod 864)
DBTW #2: 160((512*2) mod 864)
DBTW #3: 672((512*3) mod 864)

As described above, according to Configuration Method 1, base station 100 configures the transmission start position of PBCH in a circular buffer at a position contiguous with the transmission end position of the preceding DBTW, thereby improving the efficiency of transmitting bits in a circular buffer and improving the decoding performance when the bits are combined and decoded at terminal 200 on a reception side.

### Configuration Method 2

In Configuration Method 2, for example, the transmission start position of PBCH in a circular buffer may be configured at a particular position such as Redundancy version (RV). For example, the transmission start position of PBCH in a circular buffer may be configured at a fixed position for each of the plurality of DBTWs within a DBTW set.

For example, when the number of DBTWs is four, the transmission start positions of PBCH in a circular buffer may be associated with RV as follows.
DBTW #0: RV0
DBTW #1: RV2
DBTW #2: RV3
DBTW #3: RV1

Note that the order of RV is not limited to the above example. For example, RV0, RV1, RV2, RV3 may be associated with DBTWs #0 to #3, respectively.

As described above, according to Configuration Method 2, for example, by reusing the method for determining a transmission start position by RV used for a downlink shared channel (Physical Downlink Shared Channel (PDSCH)) or an uplink shared channel (Physical Uplink Shared Channel (PUSCH)), for determining the transmission start position of PBCH in a circular buffer, it is possible to unify the processing of base station 100 and terminal 200 and simplify the transmission and reception processing of base station 100 and terminal 200.

The method for determining the transmission start position of PBCH in a circular buffer has been described above.

### [SSB Burst Mapping Method]

Next, an exemplary mapping of SSB burst in each DBTW within a DBTW set is described.

### <Mapping Method 1>

In Mapping Method 1, for example, the positions at which SSBs are transmitted in each of a plurality of DBTWs within a DBTW set (e.g., candidate SSB position) may be the same. For example, the candidate SSB positions at which SSBs are transmitted in each of the plurality of DBTWs within a DBTW set may be configured at the same positions as the candidate SSB positions at which SSBs are transmitted first within the DBTWs.

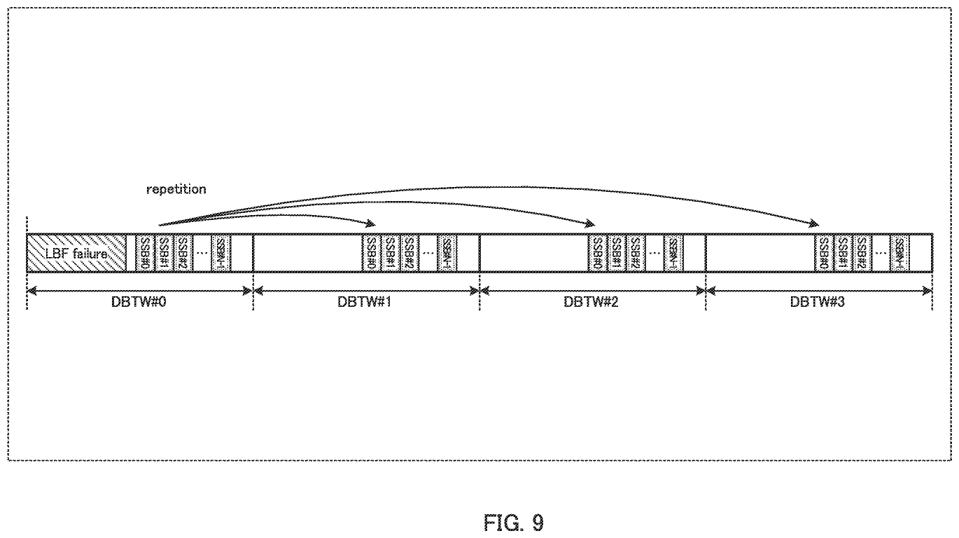

FIG. 9 illustrates exemplary mapping positions (or transmission positions) of SSBs in each of DBTWs according to Mapping Method 1.

In the example illustrated in FIG. 9, each DBTW (e.g., DBTWs #0 to #3) has two transmission opportunities for each SSB index (e.g., SSBs #0 to #N-1). In other words, in the example illustrated in FIG. 9, candidate SSB positions at which SSB burst is transmitted twice are present within a DBTW Further, in the example illustrated in FIG. 9, in DBTW #0, SSB burst cannot be transmitted at the first transmission opportunity (e.g., SSB burst transmission opportunity positioned in the first half of DBTW) due to LBT failure, and the second transmission opportunity (e.g., SSB burst transmission opportunity positioned in the second half of DBTW) is used.

In Mapping Method 1, as illustrated in FIG. 9, because the second transmission opportunity is used in DBTW #0 (DBTW in which SSBs are transmitted first within a DBTW set), base station 100 transmits SSB using the second transmission opportunity in each of DBTWs #1 to #3 (e.g., DBTWs in which the repetition SSBs are transmitted).

Note that, for example, in the case that SSBs are not transmitted in DBTW #0 due to LBT failure in DBTW #0 or the like, DBTW #1 is the DBTW in which SSBs are transmitted first, and the position at which SSBs are transmitted in DBTWs #2 and #3 may follow DBTW #1.

Further, the transmission opportunity used for a plurality of SSBs in SSB burst may be different. For example, base station 100 and terminal 200 may determine which transmission opportunity to use for each SSB index.

As described above, since the same transmission opportunity (e.g., same candidate SSB position) is used between DBTWs within a DBTW set in Mapping Method 1, terminal 200 only needs to combine PBCHs transmitted at the same candidate SSB position, thereby simplifying the PBCH combining process.

### Mapping Method 2

In Mapping Method 2, for example, the positions at which SSBs are transmitted in each of a plurality of DBTWs within a DBTW set (e.g., candidate SSB position) may be different.

Base station 100 may, for example, determine SSB transmission positions in a DBTW for each DBTW depending on an LBT result. In the conventional method, a PBCH payload is different when the candidate SSB position is different, whereas Mapping Method 2 allows combining of PBCHs between DBTWs by setting the candidate SSB positions to the same values as those of the DBTW in which SSBs are transmitted first within a DBTW set.

The candidate SSB position at which SSB is transmitted may be implicitly indicated from base station 100 to terminal 200, for example. For example, the candidate SSB position at which SSB is transmitted may be associated with a DMRS sequence type of PBCH or a PSS/SSS sequence type.

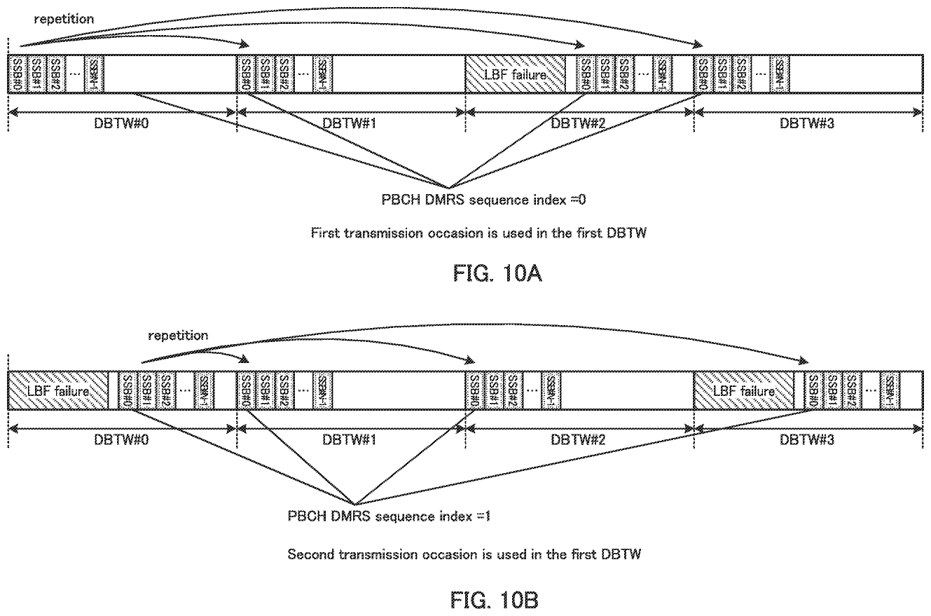

FIGS. 10A and 10B illustrate exemplary relations between DBTWs and SSB transmission positions according to Mapping Method 2. In the example illustrated in FIG. 10, two transmission opportunities for each SSB index are present within a DBTW.

For example, in the case that SSB is transmitted at the first transmission opportunity in DBTW #0, a DMRS sequence of PBCH is set to zero as illustrated in FIG. 10A, and in the case that SSB is transmitted at the second transmission opportunity in DBTW #0, the DMRS sequence of PBCH is set to one as illustrated in FIG. 10B.

As illustrated in FIG. 10A, in the case that SSB burst is transmitted at the first transmission opportunity in DBTW #0, the DMRS sequence index of PBCH may be set to zero regardless of whether the first or the second transmission opportunity is used in each of DBTWs #1 to #3. Similarly, as illustrated in FIG. 10B, in the case that SSB burst is transmitted at the second transmission opportunity in DBTW #0, the DMRS sequence index of PBCH may be set to one regardless of whether the first or the second transmission opportunity is used in each of DBTWs #1 to #3.

As described above, by the implicit indication of which transmission opportunity has been used in the DBTW in which SS B is transmitted first within a DBTW set by a DMRS sequence index, terminal 200 can recognize a candidate SSB position in the DBTW in which SSB is transmitted first also in the subsequent DBTWs, which allows combining of PBCHs between DBTWs.

Here, in the existing DBTW, a PBCH DMRS sequence is used for indicating a candidate SSB index, for example. For example, up to three bits of the candidate SSB index are implicitly indicated by the DMRS sequence. In the following description, a method for identifying an SSB by a DMRS sequence while keeping a PBCH payload the same between a plurality of DBTWs will be described.

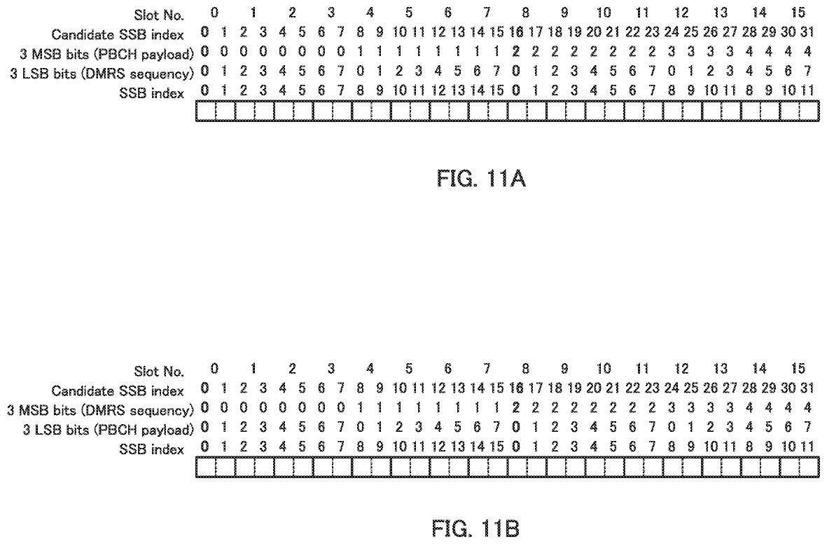

FIGS. 11A and 11B illustrate an exemplary method for identifying an SSB transmission position. In the example illustrated in FIG. 11, N_{SSB}^{QCL} is 16, and candidate SSB index 0 and candidate SSB index 16 correspond to the same SSB index 0.

FIG. 11A illustrates an example in which a candidate SSB index is indicated by the existing PBCH payload and DMRS sequence. For example, in a six-bit candidate SSB index, the upper (Most Significant Bit (MSB)) three bits are indicated in the PBCH payload, the lower (Least Significant Bit (LSB)) three bits are indicated by a DMRS sequence, and then the candidate SSB index is indicated by the combined six bits. Note that, although a six-bit candidate SSB index can originally indicate values from zero to 63, the values from 32 to 63 are omitted in FIG. 11.

In FIG. 11A, for candidate SSB index 0, the value indicated in the PBCH payload is “0.” and for candidate SSB index 16, the value indicated in the PBCH payload is “2.” Thus, in FIG. 11A, the PBCH payload used for indicating a candidate SSB index corresponding to the same SSB index varies.

In Mapping Method 2, for example, as illustrated FIG. 11B, in a six-bit candidate SSB index, MSB three bits are indicated by a DMRS sequence, and LSB three bits are indicated in a PBCH payload. For example, the MSB three bits indicated in a PBCH payload in FIG. 11A are indicated by a DMRS sequence in FIG. 11B, and the LSB three bits indicated by a DMRS sequence in FIG. 11A are indicated in a PBCH payload in FIG. 11B. In other words, in FIG. 11B, as compared with FIG. 11A, the association between a PBCH payload and DMRS sequence and a candidate SSB index (MSB three bits and LSB three bits) may be interchanged.

Thus, in FIG. 11B, while a DMRS sequence used for indicating a candidate SSB index is different between candidate SSB index 0 and candidate SSB index 16, a PBCH payload used for indicating a candidate SSB index is the same. Therefore, the position of candidate SSB (e.g., position of SSB transmission opportunity) can be recognized by a DMRS sequence in FIG. 11B, and a PBCH payload used for indicating the candidate SSB index corresponding the same SSB index can be configured to be the same value. Thus, for example, even in the case that the transmission opportunity for SSB used in each DBTW within a DBTW set is individually configured, base station 100 can configure the payload of the PBCH transmitted in each DBTW to have the same content, and can indicate the position of SSB (candidate SSB position) by a DMRS sequence to terminal 200.

Note that the number of bits of the candidate SSB index indicated in or by each of the PBCH payload and the DMRS sequence is not limited to three bits. For example, in order to establish the above-described relation, N_{SSB}^{QCL} may be set to a multiple of the number of patterns that can be indicated by a PBCH payload. For example, when the number of bits that can be indicated by a PBCH payload is three bits, the number of patterns that can be indicated is eight, and thus N_{SSB}^{QCL} may be a multiple of eight.

As described above, in Mapping Method 2, an SSB transmission opportunity used within a DBTW depending on an LBT result can be individually configured (changed) for each DBTW, so that the coverage of SSB can be enhanced while the effect of LBT failure is reduced.

The SSB burst mapping method has been described above.

As described above, in the present embodiment, base station 100 and terminal 200 configure a plurality of DBTWs (SSB burst transmission candidate sections) including at least one transmission opportunity for a plurality of SSBs (e.g., SSB burst), and perform repetition transmission of SSB or receive the repetition transmission of SSB burst in the plurality of DBTWs.

Supporting SSB repetition by introducing such a DBTW set can improve coverage of SSBs. Therefore, according to the present embodiment, it is possible to improve the reception quality of a signal (e.g., SSB) in radio communications. Further, according to the present embodiment, for example, by introducing an additional DBTW to the existing DBTW, a DBTW set can be configured (or defined) without changing a definition (e.g., specification contents) of the existing DBTW, thereby maintaining backward compatibility with legacy terminals.

The embodiment of the present disclosure has been described above.

### Other Embodiments

(1) In anon-limiting embodiment of the present disclosure, in order to have backward compatibility with legacy terminals in introduction of an additional DBTW (or DBTW set), base station 100 may, for example, perform scheduling so that the additional DBTW does not affect legacy terminals.

For example, in the case that PDSCH is transmitted in the same RB as the candidate SSB position indicated to terminal 200, rate-matching is performed on PDSCH depending on the SSB resource. Since legacy terminals do not recognize the presence of the additional DBTW, base station 100 need not schedule PDSCH in the same RB as SSB in the additional DBTW, for example.

By base station 100 performing scheduling so that additional DBTW does not affect legacy terminals as described above, backward compatibility can be maintained even when an additional DBTW is introduced in future releases.

(2) In a non-limiting embodiment of the present disclosure, a DBTW number in a DBTW set is not limited to be associated with a transmission start position of PBCH in a circular buffer. For example, a DBTW number in a DBTW set may be identified by a PSS/SSS sequence type. For example, information identifying each of the plurality of DBTWs (e.g., DBTW number) and information identifying a sequence of a synchronization signal (e.g., PSS or SSS) included in SSB (e.g., sequence number) are associated with each other. In this case, a PSS or SSS (or both) sequence type may be different between DBTWs. This allows terminal 200 to identify a DBTW number according to the PSS/SSS sequence type, which eliminates the need for blind decoding of PBCH and simplifies or accelerates the decoding process at terminal 200.

(3) In a non-limiting embodiment of the present disclosure, base station 100 need not transmit all SSBs in an additional DBTW, In other words, base station 100 need not perform repetition on all SSBs.

For example, whether to transmit SSB in an additional DBTW may be determined depending on the coverage of an SSB beam. For example, SSB transmission may be performed in an additional DBTW on an SSB that has wide beam coverage (e.g., SSB transmitted by a beam whose beamforming gain is high). On the other hand, for example, SSB transmission need not be performed in an additional DBTW on an SSB that has narrow beam coverage (e.g., SSB transmitted by a beam whose beamforming gain is low), or SSB transmission may be performed in some additional DBTWs.

In this way, by changing whether to perform repetition depending on an SSB beam can enhance resource utilization efficiency. For example, a resource in which SSB transmission is not performed may be used for another purpose.

(4) In a non-limiting embodiment of the present disclosure, a DBTW received by a legacy terminal (e.g., described as “legacy DBTW”) may be different from the initial DBTW (e.g., DBTW #0) within a DBTW set. For example, the position of the legacy DBTW may vary depending on an SSB mapping pattern. For example, in a DBTW set (DBTWs #0 to #3) including three additional DBTWs, DBTW #1 may be a legacy DBTW, and DBTW #0, 2, and 3 may be additional DBTWs.

(5) In a non-limiting embodiment of the present disclosure, a configuration on an additional DBTW may be different from a configuration on a legacy DBTW.

In the case that backward compatibility with legacy terminals is maintained, at least one DBTW may be configured as a legacy DBTW for sharing with legacy terminals. Meanwhile, since legacy terminals do not receive any additional DBTWs, a configuration different from that of the legacy DBTW may be applied to other DBTWs different from the legacy DBTW

For example, parameters such as a PSS/SSS/PBCH resource size, a time and frequency position, a PSS/SSS sequence, a DMRS sequence of PBCH, and a transmission period may be different between the legacy DBTW and other DBTWs.

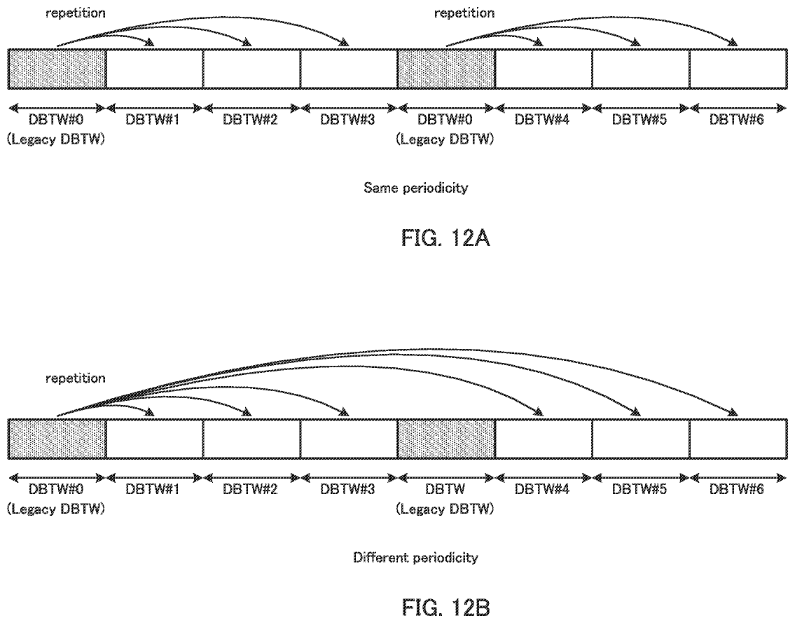

For example, regarding a transmission period, the transmission period of the additional DBTW may be different from the transmission period of SSB of the legacy DBTW. FIGS. 12A and 12B illustrate exemplary transmission periods of a legacy DBTW and an additional DBTW.

FIG. 12A illustrates an example in which transmission periods of a legacy DBTW and an additional DBTW are the same. In the additional DBTWs (DBTWs #1 to #3), base station 100 performs repetition on SSBs in the immediately preceding legacy DBTW.

FIG. 12B illustrates an example in which the transmission period of the additional DBTW is longer than the transmission period of the legacy DBTW. As illustrated in FIG. 12B, in DBTWs #1 to #6, base station 100 performs repetition transmission of SSBs of the first legacy DBTW (DBTW #0), but does not perform repetition transmission on the second legacy DBTW. In FIG. 12B, as compared with FIG. 12A, while the transmission period of the DBTW on which repetition is performed is longer, the number of repetitions is high, so that the coverage can be increased.

In this way, applying a configuration different from that of the legacy DBTW to additional DBTWs makes it possible to respond to functionality that may be required in future releases, for example.

(6) In anon-limiting embodiment of the present disclosure, terminal 200 receives a control resource set (CORESET) #0 for receiving System Information Block (SIB), after acquiring PBCH. Here, CORESET #0 may be configured to be received by terminal 200 following the repetition transmission of SSB. Receiving CORESET #0 after repetition at terminal 200 as described above makes it possible to shorten a period until the initial access is completed.

(7) Although transmission of SSB has been described in a non-limiting embodiment of the present disclosure, a targeted signal is not limited to SSB and may be another signal. For example, the repetition method according to a non-limiting embodiment of the present disclosure may be applied to wake up signals. For example, a plurality of windows for transmitting Wake up signals may be defined (e.g., a set of Wake tip signal transmission candidate sections may be defined), initial transmission may be performed in the first window, and repetition transmission may be performed in the subsequent windows. This can increase the coverage of wake up signals.

(8) Values such as the number of SSBs, the number of candidate SSB positions, the number of slots, frequencies (e.g., 52.6 GHz to 71 GHz), SCS, a DBTW size, the size of a DBTW set, the number of repetitions, and the like used in a non-limiting embodiment of the present disclosure are merely examples and are not limited.

(9) In anon-limiting embodiment of the present disclosure, a case where the DBTW size (time length of DBTW) within a DBTW set is set to 1 ms (e.g., ⅕ of a half frame (5 ms)) in the case of 480 kHz SCS has been described as an example, but the present disclosure is not limited thereto. For example, the DBTW size may be a size less than ⅕ of a half frame size or a size greater than ⅕ of a half frame size. For example, the DBTW size in the case of 480 kHz SCS may be set to ¼ of 1.25 ms (e.g., half frame (5 ms)).

(10) In a non-limiting embodiment of the present disclosure, a DBTW has been described as an example of an SSB burst transmission candidate section, but the present disclosure is not limited thereto, and the SSB burst transmission candidate section may be a section different from DBTW. For example, SSB repetition transmission may be applied in a bandwidth different from an NR-U band, and in this case, the SSB burst transmission candidate section may correspond to a section different from DBTW

### Supplement

Information indicating whether terminal 200 supports the functions, operations, or processes described in the above-described embodiments may be transmitted (or indicated) from terminal 200 to base station 100 as capability information or a capability parameter of terminal 200.

The capability information may include an information element (1E) individually indicating whether terminal 200 supports at least one of the functions, operations, or processes described in the above-described embodiments. Alternatively, the capability information may include an information element indicating whether terminal 200 supports a combination of any two or more of the functions, operations, and processing described in the above embodiment.

Base station 100 may determine (or assume) the function, operation, or process supported (or not supported) by terminal 200 of the transmission source of the capability information, based on the capability information received from terminal 200, for example. Base station 100 may perform an operation, processing, or control corresponding to a determination result based on the capability information. For example, base station 100 may control SSB transmission and reception based on the capability information received from terminal 200.

Note that the fact that terminal 200 does not support some of the functions, operations, or processes described in the above-described embodiments may be read as that some of the functions, operations, or processes are limited in terminal 200. For example, information or a request on such limitation may be indicated to base station 100.

Information on the capability or limitation of terminal 200 may be defined, for example, in the standard, or may be implicitly indicated to base station 100 in association with information known to base station 100 or information transmitted to base station 100.

### (Control Signals)

In the present disclosure, the downlink control signal (or downlink control information) related to an embodiment of the present disclosure may be, for example, a signal (or information) transmitted through a physical downlink control channel (PDCCH) of the physical layer or may be a signal (or information) transmitted in the medium access control control element(MAC CE) of the higher layer or the radio resource control (RRC). Further, the signal (or information) is not necessarily indicated by the downlink control signal, but may be predefined in a specification (or standard) or may be preconfigured for the base station and the terminal.

In the present disclosure, the uplink control signal (or uplink control information) related to an embodiment of the present disclosure may be, for example, a signal (or information) transmitted through a PUCCH of the physical layer or may be a signal (or information) transmitted in the MAC CE of the higher layer or the RRC. Further, the signal (or information) is not necessarily indicated by the uplink control signal, but may be predefined in a specification (or standard) or may be preconfigured for the base station and the terminal. Further, the uplink control signal may be replaced with, for example, uplink control information (UCI), the 1st stage sidelink control information (SCI) or the 2nd stage SCI.

### (Base Station)

In an exemplary embodiment of the present disclosure, the base station may be a transmission reception point (TRP), a clusterhead, an access point, a remote radio head (RRH), an eNodeB (eNB), gNodeB (gNB), a base station (BS), a base transceiver station (BTS), a base unit or a gateway, for example. Further, in the side link communication, the terminal may play a role of a base station. Furthermore, instead of the base station, a relay apparatus that relays communication between a higher node and a terminal may be used. Moreover, a road side device may be used.

### (Uplink/Downlink/Sidelink)

An exemplary embodiment of the present disclosure may be applied to, for example, any of uplink, downlink, and sidelink. An exemplary embodiment of the present disclosure may be applied to, for example, uplink channels, such as physical uplink shared channel (PUSCH), physical uplink control channel (PUCCH), and physical random access channel (PRACH), downlink channels, such as physical downlink shared channel (PDSCH), PDCCH, and physical broadcast channel (PBCH), or sidelink channels, such as physical sidelink shared channel (PSSCH), physical sidelink control channel (PSCCH), and physical sidelink broadcast channel (PSBCH).

Note that, PDCCH, PDSCH, PUSCH, and PUCCH are examples of a downlink control channel, a downlink data channel, an uplink data channel, and an uplink control channel, respectively. Further, PSCCH and PSSCH are examples of a side link control channel and a sidelink data channel, respectively. Further, PBCH and PSBCH are examples of broadcast channels, and PRACH is an example of a random access channel.

### (Data Channel/Control Channel)

An exemplary embodiment of the present disclosure may be applied to, for example, any of the data channels and control channels. For example, the channel in an exemplary embodiment of the present disclosure may be replaced with one of data channels including PDSCH, PUSCH and PSSCH or control channels including PDCCH, PUCCH, PBCH, PSCCH, and PSBCH.

### (Reference Signals)

In an exemplary embodiment of the present disclosure, the reference signals are, for example, signals known to both a base station and a mobile station and each reference signal may be referred to as a reference signal (RS) or sometimes a pilot signal. The reference signal may be any of a demodulation reference signal (DMRS), a channel state information-reference signal (CSI-RS), a tracking reference signal (TRS), a phase tracking reference signal (PTRS), a cell-specific reference signal (CRS), or a sounding reference signal (SRS).

### (Time Intervals)

In an exemplary embodiment of the present disclosure, time resource units are not limited to one or a combination of slots and symbols, and may be time resource units, such as frames, superframes, subframes, slots, time slots, subslots, minislots, or time resource units, such as symbols, orthogonal frequency division multiplexing (OFDM) symbols, single carrier-frequency division multiplexing (SC-FDMA) symbols, or other time resource units. The number of symbols included in one slot is not limited to any number of symbols exemplified in the embodiments described above, and may be other numbers of symbols.

### (Frequency Bands)

An exemplary embodiment of the present disclosure may be applied to any of a licensed band and an unlicensed band.

### (Communication)

An exemplary embodiment of the present disclosure may be applied to any of communication between a base station and a terminal (Uu-link communication), communication between a terminal and a terminal (sidelink communication), and vehicle to everything (V2X) communication. The channels in an exemplary embodiment of the present disclosure may be replaced With any of a PSCCH, a PSSCH, a physical sidelink feedback channel (PSFCH), a PSBCH, a PDCCH, a PUCCH, a PDSCH, a PUSCH, and a PBCH.

Further, an exemplary embodiment of the present disclosure may be applied to any of a terrestrial network or a network other than a terrestrial network (NTN: non-terrestrial network) using a satellite or a high altitude pseudo satellite (HAPS). In addition, an exemplary embodiment of the present disclosure may be applied to a network having a large cell size, and a terrestrial network with a large delay compared with a symbol length or a slot length, such as an ultra-wideband transmission network.

### (Antenna Ports)

In an exemplar-y embodiment of the present disclosure, an antenna port refers to a logical antenna (antenna group) formed of one or more physical antenna(s). For example, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal station is allowed to transmit a reference signal. The antenna port may also be defined as the minimum unit for multiplication of a precoding vector weighting.

### <50 NR System Architecture and Protocol Stacks>

3GPP has been working at the next release for the 5th generation cellular technology, simply called 5G, including the development of a new radio (NR) access technology operating in frequencies ranging up to 100 GHz. The first version of 5G standard was initially delivered in late 2017, which allows proceeding to trials and commercial deployments of 5 NR standard-compliant terminals, e.g., smartphones.

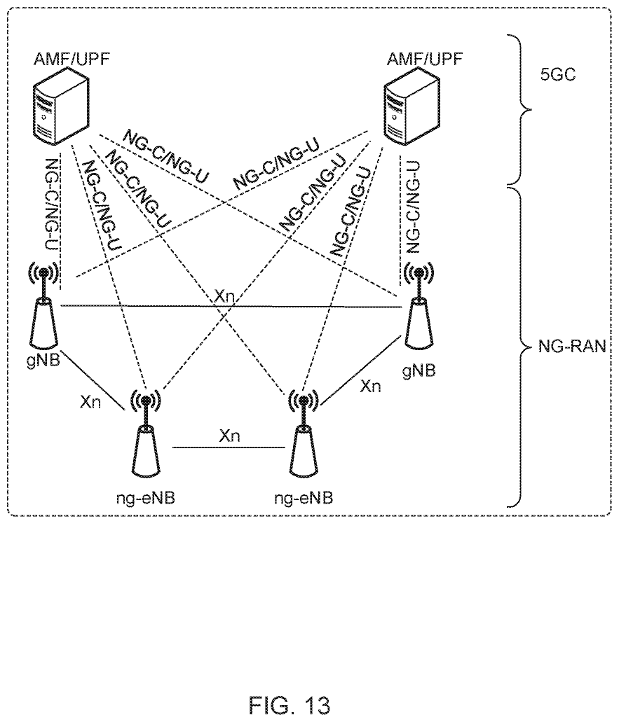

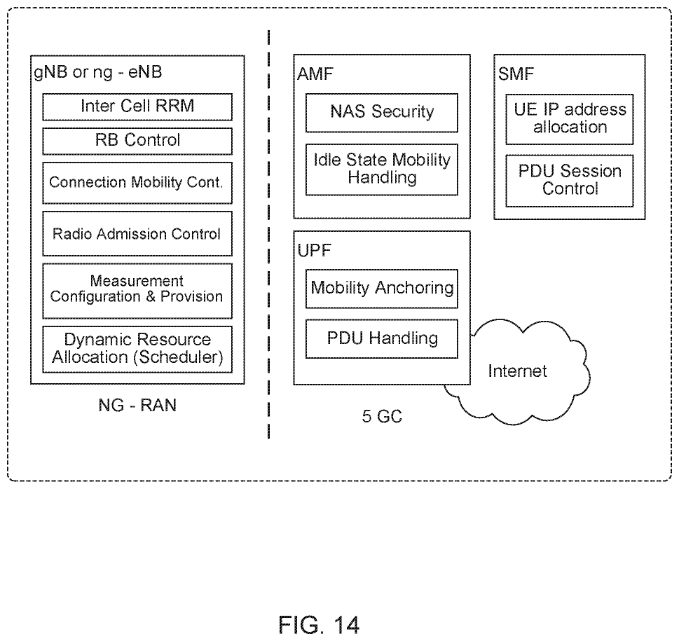

For example, the overall system architecture assumes a Next Generation-Radio Access Network (NG-RAN) that includes gNBs. The gNBs provide the NG-radio access user plane (SDAP/PDCP/RLC/MAC/PHY) and control plane (RR) protocol terminations towards a UE. The gNBs are interconnected with each other via an Xn interface. The gNBs are also connected to the Next Generation Core (NGC) via the Next Generation (NG) interface, more specifically to the Access and Mobility Management Function (AMF; e.g. a particular core entity performing the AMF) via the NG-C interface, and to the User Plane Function (UPF; e.g., a particular core entity performing the UPF) via the NG-U interface. The NG-RAN architecture is illustrated in FIG. 13 (see, e.g., 3GPP TS 38.300 v15.6.0, section 4).

The user plane protocol stack for NR (see, e.g., 3GPP TS 38.300, section 4.4.1) includes the Packet Data Convergence Protocol (PDCP, see clause 6.4 of TS 38.300) Radio Link Control (RLC, see clause 6.3 of TS 38.300) and Medium Access Control (MAC, see clause 6.2 of TS 38.300) sublayers, which are terminated in the gNB on the network side, Additionally, a new access stratum (AS) sublayer (Service Data Adaptation Protocol: SDAP) is introduced above the PDCP (see, e.g., clause 6.5 of 3GPP TS 38.300). A control plane protocol stack is also defined for NR (see, e.g., TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For example, the Medium-Access-Control layer handles logical-channel multiplexing, and scheduling and scheduling-related functions, including handling of different numerologies.

The physical layer (PHY) is, for example, responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For example, the physical channels include a Physical Random Access Channel (PRACH), Physical Uplink Shared Channel (PUSCH), and Physical Uplink Control Channel (PUCCH) as uplink physical channels, and a Physical Downlink Shared Channel (PDSCH), Physical Downlink Control Channel (PDCCH), and Physical Broadcast Channel (PBCH) as downlink physical channels.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, the eMBB is expected to support peak data rates (20 Gbps for downlink and 10 Gbps for uplink) and user-experienced data rates in the order of three times what is offered by IMT-Advanced. Meanwhile, in a case of the URLLC, the tighter requirements are put on ultra-low latency (0.5 ms for each of UL and DL for user plane latency) and high reliability (1-10-5 within 1 ms). Finally, the mMTC may preferably require high connection density (1,000,000 devices/km2 in an urban environment), large coverage in harsh environments, and extremely long-life battery for low cost devices (15 years).

Thus, the OFDM numerology (e.g., subcarrier spacing, OFDM symbol duration, cyclic prefix (CP) duration, the number of symbols per scheduling interval) that is suitable for one use case might not work well for another. For example, low-latency services may preferably require a shorter symbol duration (and thus larger subcarrier spacing) and/or fewer symbols per scheduling interval (also referred to as TTI) than an mMTC service. Furthermore, deployment scenarios with large channel delay spreads may preferably require a longer CP duration than scenarios with short delay spreads. The subcarrier spacing may be optimized accordingly to retain the similar CP overhead. NR may support more than one value of subcarrier spacing. Correspondingly, subcarrier spacing of 15 kHz, 30 kHz, 60 kHz . . . are currently considered. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR, for each numerology and carrier, a resource grid of subcarriers and OFDM symbols is defined for each of uplink and downlink. Each element in the resource grid is called a resource element and is identified based on the frequency index in the frequency domain and the symbol position in the time domain (see 3GPP TS 38.211 v15.6.0).

<5G NR Functional Split between NC-RAN and 5CC>

FIG. 14 illustrates functional split between NG-RAN and 5GC. An NG-RAN logical node is a gNB or ng-eNB. The 5GC has logical nodes AMF, UPF, and SMF.

For example, the gNB and ng-eNB host the following main functions:
Functions for radio resource management such as radio bearer control, radio admission control, connection mobility control, dynamic allocation of resources to UEs in both uplink and downlink (scheduling);
IP header compression, encryption, and integrity protection of data;
Selection of an AMF at UE attachment when no routing to an AMF can be determined from the information provided by the UE;
Routing of user plane data towards UPF(s);
Routing of control plane information towards AMF;
Connection setup and release;
Scheduling and transmission of paging messages;
Scheduling and transmission of system broadcast information (originated from the AMF or Operation, Admission, Maintenance (OAM));
Measurement and measurement reporting configuration for mobility and scheduling;
Transport level packet marking in the uplink;
Session management;
Support of network slicing,
QoS Flow management and mapping to data radio bearers;
Support of UEs in RRC INACTIVE state;
Distribution function for NAS messages; Radio access network sharing;
Dual Connectivity; and
Tight interworking between NR and E-UTRA.

The access and mobility management function (AMF) hosts the following main functions:
Non-Access Stratum (NAS) signaling termination function;
NAS signaling security;
Access Stratum (AS) security control;
Inter Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

Furthermore, the user plane function (UPF) hosts the following main functions:
Anchor point for intra-/inter-RAT mobility (when applicable);
External protocol data unit (PDU) session point of interconnect to a data network;
Packet routing and forwarding;
Packet inspection and user plane part of policy rule enforcement;
Traffic usage reporting;
Uplink classifier to support routing traffic flows to a data network;
Branching point to support multi-homed PDU session;
QoS handling for user plane (e.g. packet filtering, gating, and UL/DL rate enforcement);
Uplink traffic verification (SDF to QoS flow mapping); and
Downlink packet buffering and downlink data indication triggering.

Finally, the session management function (SMF) hosts the following main functions:
Session management;
UE IP address allocation and management;
Selection and control of UPF;
Configuration function of traffic steering at a user plane function (UPF) to route traffic to proper destination;
Control part of policy enforcement and QoS; and
Downlink data indication

### <RRC Connection Setup and Reconfiguration Procedures>

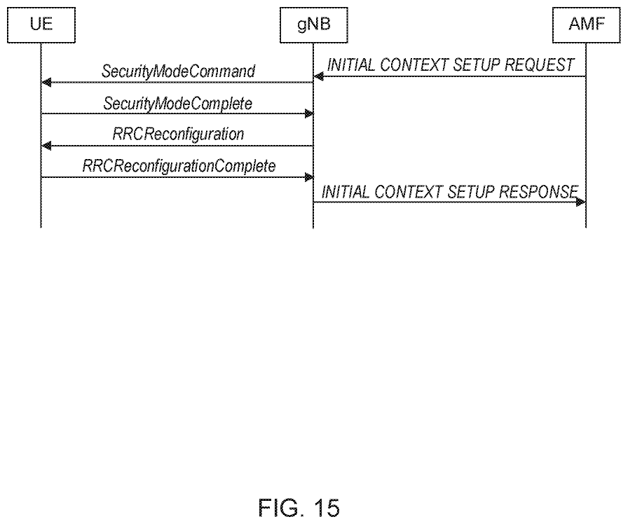

FIG. 15 illustrates some interactions between a UE, gNB, and AMF (an 5GC entity) in the context of a transition of the UE from RRC IDLE to RRC CONNECTED for the NAS part (see TS 38.300 v15.6.0).

RRC is a higher layer signaling (protocol) used for UE and gNB configuration. This transition involves that the AMF prepares the UE context data (including, for example, PDU session context, security key, UE radio capability, and E security capabilities, etc.) and transmits the UE context data to the gNB with an INITIAL CONTEXT SETUP REQUEST. Then, the gNB activates the AS security with the UE, which is performed by the gNB transmitting a SecurityModeCommand message to the UE and by the UE responding to the gNB with a SecurityModeComplete message. Afterwards, the gNB performs the reconfiguration to set up the Signaling Radio Bearer 2 (SRB2) and Data Radio Bearer(s) (DRB(s)) by transmitting an RRCReconfiguration message to the UE and, in response, receiving an RRCReconfigurationComplete from the UE. For a signaling-only connection, the steps relating to the RRCReconfiguration are skipped since the SRB2 and DRBs are not setup. Finally, the gNB indicates to the AMF that the setup procedure is completed with an INITIAL CONTEXT SETUP RESPONSE.

In the present disclosure, thus, an entity (e.g., AMF. SMF, etc.) of the 5th Generation Core (5GC) is provided that includes control circuitry, which, in operation, establishes a Next Generation (NG) connection with a gNodeB, and a transmitter, which in operation, transmits an initial context setup message, via the NG connection, to the gNodeB to cause a signaling radio bearer setup between the gNodeB and user equipment (UE). In particular, the gNodeB transmits a radio resource control (RRC) signaling containing a resource allocation configuration information element (1E) to the UE via the signaling radio bearer. The UE then performs an uplink transmission or a downlink reception based on the resource allocation configuration.

### <Usage Scenarios of IMT for 2020 and Beyond>

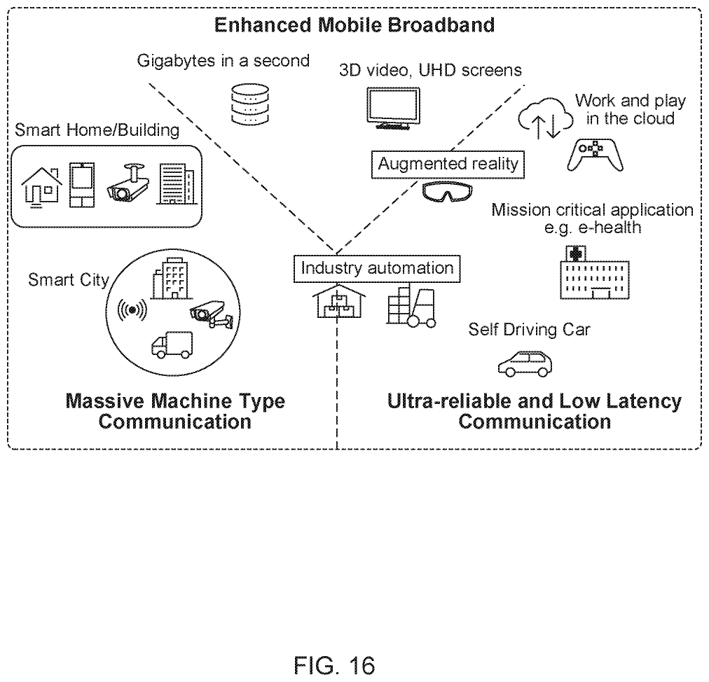

FIG. 16 illustrates some of the use cases for 5G NR. In the 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 16 illustrates some examples of envisioned usage scenarios for IMT for 2020 and beyond (see, e.g., ITU-R M. 2083 FIG. 2).

The URLLC use case has stringent requirements for capabilities such as throughput, latency, and availability. The URLLC use case has been envisioned as one of element techniques to enable future vertical applications such as wireless control of industrial manufacturing or production processes, remote medical surgery, distribution automation in a smart grid, transportation safety, etc. Ultra-reliability for the URLLC is to be supported by identifying the techniques to meet the requirements set by TR 38.913. For NR URLLC in Release 15, key requirements include a target user plane latency of 0.5 ms for uplink (UL) and 0.5 ms for downlink (DL). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for the URLLC, more compact DCI formats, repetition of PDCCH, etc. However, the scope may widen for achieving ultra-reliability as the NR becomes more stable and developed (for NR URLLC key requirements). Particular use cases of NR URLLC in Release 15 include augmented reality/virtual reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. The pre-emption means that a transmission for which resources have already been allocated is stopped, and the already allocated resources are used for another transmission that has been requested later but has lower latency/higher priority requirements. Accordingly, the already granted transmission is replaced with a later transmission. The pre-emption is applicable independent of the particular service type. For example, a transmission for a service-type A (URLLC) may be replaced with a transmission for a service type B (such as eMBB). Technology enhancements with respect to reliability improvement include dedicated CQI/MCS tables for the target BLER of 1E-5.

The use case of the mMTC (massive machine type communication) is characterized by a very large number of connected devices typically transmitting a relatively low volume of non-delay sensitive data. Devices are required to be low cost and to have a very long battery life. From the NR perspective, utilizing very narrow bandwidth parts is one possible solution to have power saving from the UE perspective and enable the long battery life.

As mentioned above, it is expected that the scope of reliability improvement in NR becomes wider. One key requirement to all the cases, and especially necessary for the URLLC and mMTC for example, is high reliability or ultra-reliability. Several mechanisms can be considered to improve the reliability from the radio perspective and network perspective. In general, there are a few key important areas that can help improve the reliability. These areas include compact control channel information, data/control channel repetition, and diversity with respect to the frequency, time, and/or spatial domain. These areas are applicable to reliability improvement in general, regardless of particular communication scenarios.

For NR URLLC, further use cases with tighter requirements have been considered such as factory automation, transport industry, and electrical power distribution. The tighter requirements are higher reliability (up to 10-6 level), higher availability, packet size of up to 256 bytes, time synchronization down to the order of a few us where the value can be one or a few μs depending on frequency range and short latency in the order of 0.5 to 1 ms (e.g., target user plane latency of 0.5 ms) depending on the use cases.

Moreover, for NR URLLC, several technology enhancements from the physical layer perspective have been identified. These technology enhancements include Physical Downlink Control Channel (PDCCH) enhancements related to compact DC, PDCCH repetition, and increased PDCCH monitoring. In addition. Uplink Control Information (UCI) enhancements are related to enhanced Hybrid Automatic Repeat Request (HARQ) and CS1 feedback enhancements. Also, PUSCH enhancements related to mini-slot level hopping and retransmission/repetition enhancements have been identified. The term “mini-slot” refers to a transmission time interval (TTI) including a smaller number of symbols than a slot (a slot includes fourteen symbols).

### <QoS Control>

The 5G Quality of Service (QoS) model is based on QoS flows and supports both QoS flows that require guaranteed flow bit rate (GBR QoS flows) and QoS flows that do not require guaranteed flow bit rate (non-GBR QoS Flows). At the NAS level, the QoS flow is thus the finest granularity of QoS differentiation in a PDU session. A QoS flow is identified within a PDU session by a QoS flow ID (QFI) carried in an encapsulation header over the NG-U interface.

For each UE, the 5GC establishes one or more PDU sessions. For each UE, the NG-RAN establishes at least one Data Radio Bearer (DRB) together with the PDU session, for example as illustrated above with reference to FIG. 15. Additional DRB(s) for QoS flow(s) of that PDU session can be subsequently configured (it is up to NG-RAN when to do so). The NG-RAN maps packets belonging to different PDU sessions to different DRBs. NAS level packet filters in the UE and 5GC associate UL and DL packets with QoS flows, whereas AS-level mapping rules in the U E and in the NG-RAN associate UL and DL QoS flows with DRBs.

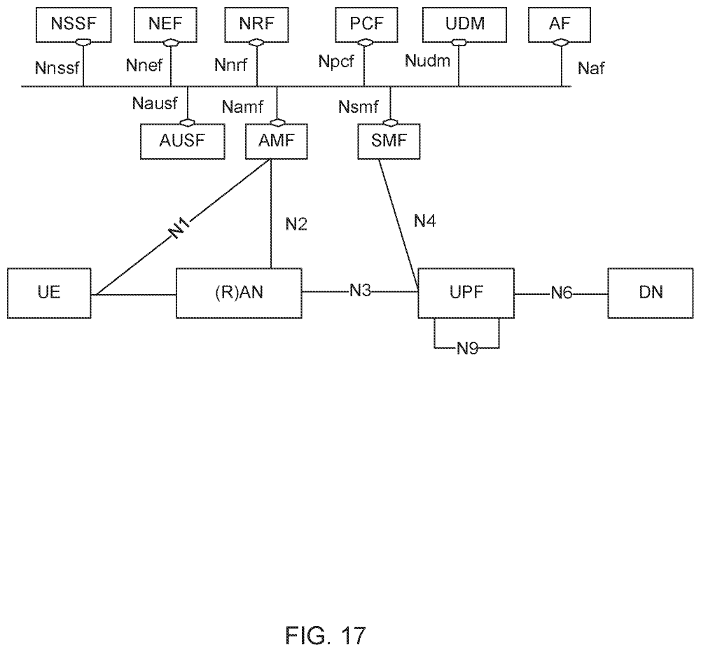

FIG. 17 illustrates a 5G NR non-roaming reference architecture (see TS 23.501 v16.1.0, section 4.23). An Application Function (AF), for example, an external application server hosting 5G services exemplified in FIG. 16, interacts with the 3GPP core network in order to provide services, for example, to support application influence on traffic routing, accessing a Network Exposure Function (NEF) or interacting with the policy framework for policy control (see Policy Control Function, PCF), for example, QoS control. Based on operator deployment, application functions considered to be trusted by the operator can be allowed to interact directly with relevant network functions. Application functions not allowed by the operator to access directly the network functions use the external exposure framework via the NEF to interact with relevant network functions.

FIG. 17 illustrates further functional units of the 5G architecture, namely a Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), for example, operator services, Internet access, or 3rd party services. All of or a part of the core network functions and the application services may be deployed and running on cloud computing environments.

In the present disclosure, thus, an application server (e.g., AF of the 5G architecture), is provided that includes a transmitter, which in operation, transmits a request containing a QoS requirement for at least one of the URLLC, eMMB, and mMTC services to at least one of functions (e.g., NEF, AMF, SMF, PCF, UPF, etc.) of the 5GC to establish a PDU session including a radio bearer between a gNodeB and a UE in accordance with the QoS requirement, and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, an FPGA(Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g. cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above nonlimiting examples.

A base station according to an embodiment of the present disclosure includes: control circuitry, which in operation, configures a plurality of sections including at least one transmission opportunity for a plurality of synchronization signal blocks; and transmission circuitry, which in operation, performs repetition transmission of the plurality of synchronization signal blocks in the plurality of sections.

In the embodiment of the present disclosure, each of the plurality of sections is a Discovery burst transmission window (DBTW), and the transmission circuitry performs the repetition transmission in a plurality of the DBTWs.

In the embodiment of the present disclosure, positions at which the plurality of synchronization signal blocks are respectively transmitted in each of the plurality of sections are the same.

In the embodiment of the present disclosure, positions at which the plurality of synchronization signal blocks are respectively transmitted in each of the plurality of sections are different.

In the embodiment of the present disclosure, information identifying each of the plurality of sections and a transmission start position of a broadcast signal in a circular buffer are associated with each other, the broadcast signal being included in each of the plurality of synchronization signal blocks.

In the embodiment of the present disclosure, the transmission start position is determined based on a payload size of the broadcast signal, a resource size assigned to the broadcast signal, and the information identifying each of the plurality of sections.

In the embodiment of the present disclosure, the transmission start position is a fixed position for each of the plurality of sections.

In the embodiment of the present disclosure, information identifying each of the plurality of sections and information identifying a sequence of a synchronization signal included in each of the plurality of synchronization signal blocks are associated with each other.

In the embodiment of the present disclosure, the plurality of sections includes a first section supported by a legacy terminal and a second section different from the first section, and a configuration on the second section is different from a configuration on the first section.

A terminal according to an embodiment of the present disclosure includes: control circuitry, which in operation, configures a plurality of sections including at least one transmission opportunity for a plurality of synchronization signal blocks; and reception circuitry, which in operation, receives a repetition transmission of the plurality of synchronization signal blocks in the plurality of sections.

In a communication method according to an embodiment of the present disclosure, a base station configures a plurality of sections including at least one transmission opportunity for a plurality of synchronization signal blocks, and performs repetition transmission of the plurality of synchronization signal blocks in the plurality of sections.

In a communication method according to an embodiment of the present disclosure, a terminal configures a plurality of sections including at least one transmission opportunity for a plurality of synchronization signal blocks, and receives a repetition transmission of the plurality of synchronization signal blocks in the plurality of sections.

The disclosure of Japanese Patent Application No. 2021-195491, filed on Dec. 1, 2021, including the specification, drawings and abstract, is incorporated herein by reference in its entirety.

### INDUSTRIAL APPLICABILITY

An exemplary embodiment of the present disclosure is useful for radio communication systems.

### REFERENCE SIGNS LIST

100 Base station
101, 201 Receiver
102 Demodulator/decoder
103 Carrier sensor
104 Scheduler
105, 206 Control information holder
106 SSB generator
107, 207 Data/control information generator
108, 208 Encoder/modulator
109, 209 Transmitter
200 Terminal
202 Data/control information demodulator/decoder
203 SS detector
204 PBCH demodulator/decoder
205 Controller

1. Abase station, comprising:
control circuitry, which in operation, configures a plurality of sections including at least one transmission opportunity for a plurality of synchronization signal blocks; and
transmission circuitry, which in operation, performs repetition transmission of the plurality of synchronization signal blocks in the plurality of sections.

2. The base station according to claim 1, wherein
each of the plurality of sections is a Discovery burst transmission window (DBTW), and
the transmission circuitry performs the repetition transmission in a plurality of the DBTWs.

3. The base station according to claim 1, wherein
positions at which the plurality of synchronization signal blocks are respectively transmitted in each of the plurality of sections are the same.

4. The base station according to claim 1, wherein
positions at which the plurality of synchronization signal blocks are respectively transmitted in each of the plurality of sections are different.

5. The base station according to claim 1, wherein
information identifying each of the plurality of sections and a transmission start position of a broadcast signal in a circular buffer are associated with each other, the broadcast signal being included in each of the plurality of synchronization signal blocks.

6. The base station according to claim 5, wherein
the transmission start position is determined based on a payload size of the broadcast signal, a resource size assigned to the broadcast signal, and the information identifying each of the plurality of sections.

7. The base station according to claim 5, wherein
the transmission start position is a fixed position for each of the plurality of sections.

8. The base station according to claim 1, wherein
information identifying each of the plurality of sections and information identifying a sequence of a synchronization signal included in each of the plurality of synchronization signal blocks are associated with each other.

9. The base station according to claim 1, wherein
the plurality of sections includes a first section supported by a legacy terminal and a second section different from the first section, and
a configuration on the second section is different from a configuration on the first section.

10. A terminal, comprising:
control circuitry, which in operation, configures a plurality of sections including at least one transmission opportunity for a plurality of synchronization signal blocks; and
reception circuitry, which in operation, receives a repetition transmission of the plurality of synchronization signal blocks in the plurality of sections.

11. A communication method, comprising:
configuring, by a base station, a plurality of sections including at least one transmission opportunity for a plurality of synchronization signal blocks; and
performing, by the base station, repetition transmission of the plurality of synchronization signal blocks in the plurality of sections.

12. A communication method, comprising:
configuring, by a terminal, a plurality of sections including at least one transmission opportunity for a plurality of synchronization signal blocks; and
receiving, by the terminal, a repetition transmission of the plurality of synchronization signal blocks in the plurality of sections.
